(19) United States
(12) Patent Application Publication
(10) Pub. No.: US 2021/0233217 A1
(43) Pub. Date: Jul. 29, 2021

(54) IMAGE RESTORATION DEVICE AND RESTORATION MODEL GENERATION DEVICE

(71) Applicant: AISIN SEIKI KABUSHIKI KAISHA, Kariya-shi (JP)

(72) Inventors: Hirotaka MARUYAMA, Kariya-shi (JP); Yoshihito KOKUBO, Kariya-shi (JP); Yoshihisa SUETSUGU, Kariya-shi (JP)

(73) Assignee: AISIN SEIKI KABUSHIKI KAISHA, Kariya-shi (JP)

(21) Appl. No.: 17/158,200

(22) Filed: Jan. 26, 2021

(30) Foreign Application Priority Data
Jan. 29, 2020 (JP) 2020-012966

(51) Int. Cl. G06T 5/00; G06N 20/00; G06K 9/00

(52) U.S. Cl. CPC G06T 5/006; G06N 20/00; G06T 2207/30252; G06T 2207/20081; G06T 2207/20172; G06K 9/00791

(57) ABSTRACT

An image restoration device includes an acquisition processing unit configured to acquire a captured image obtained by an imaging unit capturing surroundings of a vehicle, and a restoration processing unit. In a case where the captured image includes a stained area caused by a stain of an optical system of the imaging unit, the restoration processing unit is configured to output a restored image corresponding to the captured image acquired by the acquisition processing unit based on a restoration model pre-trained by a machine learning method to output the restored image serving as the captured image in response to an input of the captured image, the restored image in which the stained area is reduced in a different degree in accordance with a position of the stained area in the captured image.

### CROSS REFERENCE TO RELATED APPLICATIONS

This application is based on and claims priority under 35 U.S.C. § 119 to Japanese Patent Application 2020-012966, filed on Jan. 29, 2020, the entire content of which is incorporated herein by reference.

### TECHNICAL FIELD

This disclosure generally relates to an image restoration device and a restoration model generation device.

### BACKGROUND DISCUSSION

A driver monitors surroundings of a vehicle by using a display device which outputs captured image captured by an imaging unit mounted on the vehicle. However, in a case where the captured image includes stained areas caused by stains such as water drops, dusts, or dirt adhered to an optical system (for example, a lens) of the imaging unit, the driver may not appropriately monitor surroundings of the vehicle if the captured image is outputted without being processed. Therefore, the technology for generating a restored image restored from the captured image to reduce the stained areas has been considered.

The conventional technologies such as a technology disclosed in JP2017-092622A (hereinafter referred to as Patent reference 1) generally reduce all the stained areas equally regardless of the positions of the stained areas in the captured image. However, it is not efficient to remove the stained areas where the necessity of visual confirmation by the passenger is low by an equivalent degree of the area where the necessity of visual confirmation by the passenger is high.

A need thus exists for an image restoration device and a restoration model generation device which are not susceptible to the drawback mentioned above.

### SUMMARY

According to an aspect of this disclosure, an image restoration device includes an acquisition processing unit configured to acquire a captured image obtained by an imaging unit capturing surroundings of a vehicle, and a restoration processing unit. In a case where the captured image includes a stained area caused by a stain of an optical system of the imaging unit, the restoration processing unit is configured to output a restored image corresponding to the captured image acquired by the acquisition processing unit based on a restoration model pre-trained by a machine learning method to output the restored image serving as the captured image in response to an input of the captured image, the restored image in which the stained area is reduced in a different degree in accordance with a position of the stained area in the captured image.

According to another aspect of this disclosure, a restoration model generation device includes an acquisition processing unit configured to acquire a captured image obtained by an imaging unit capturing surroundings of a vehicle, the captured image including a stained area caused by a stain of an optical system of the imaging unit, a restoration processing unit configured to output the restored image corresponding to the captured image acquired by the acquisition processing unit based on a restoration model outputting the restored image serving as the captured image in response to an input of the captured image, the restored image in which the stained area is reduced, and a learning processing unit configured to train the restoration model to output the restored image in response to the input of the captured image, the restored image serving as the captured image in which the stained area is reduced in a different degree in accordance with a position of the stained area in the captured image by a machine learning method based on the restored image, an ideal image, and a map, the restored image outputted by the restoration processing unit, the ideal image serving as the captured image in which the stained area is removed, and the map indicating correspondence between any position in the captured image and a restoration degree indicating a degree to reduce the stained area.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is an exemplified and schematic view illustrating a configuration of a vehicle on which an image restoration device according to an embodiment disclosed here is mounted;

FIG. 2 is an exemplified and schematic view illustrating an example of a captured image obtained by an imaging unit of the embodiment;

FIG. 3 is an exemplified and schematic block diagram illustrating functions of the image restoration device of the embodiment;

FIG. 4 is an exemplified and schematic view for explaining a restoration model of the embodiment;

FIG. 5 is an exemplified and schematic view for explaining a first restoration example executed by the restoration model of the embodiment;

FIG. 6 is an exemplified and schematic view for explaining a second restoration example executed by the restoration model of the embodiment;

FIG. 7 is an exemplified and schematic view for explaining a third restoration example executed by the restoration model of the embodiment;

FIG. 8 is an exemplified and schematic view for explaining a fourth restoration example executed by the restoration model of the embodiment;

FIG. 9 is an exemplified flowchart illustrating a series of processes executed to restore the captured image by the image restoration device of the embodiment;

FIG. 10 is an exemplified and schematic block diagram illustrating a configuration of a restoration model generation device of the embodiment;

FIG. 11 is an exemplified flowchart illustrating a series of processes executed when the restoration model generation device generates the restoration model in a case where an importance map is predetermined according to the embodiment;

FIG. 12 is an exemplified flowchart illustrating a series of processes executed when the restoration model generation device generates the restoration model in a case where an importance map is not predetermined according to the embodiment; and

FIG. 13 is an exemplified and schematic block diagram illustrating a hardware configuration of an information processing device for the image restoration device and the restoration model generation device of the embodiment.

### DETAILED DESCRIPTION

An embodiment and modified examples of the disclosure will hereunder be explained with reference to the drawings. Configurations of the embodiment and modified examples described below, and operations and effects brought about by such configurations are examples and not limited to the descriptions described below.

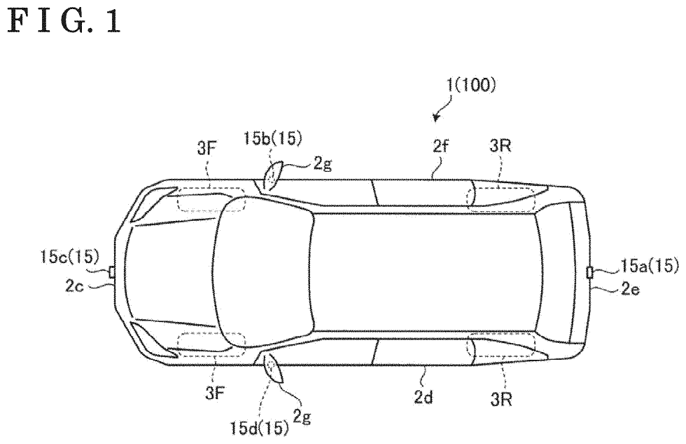

An image restoration device 100 of the embodiment shown in FIG. 1 is mounted on a four-wheel vehicle 1 including two front-wheels 3F, 3F and two rear-wheels 3R, 3R.

The vehicle 1 includes plural (for example, four, in the example illustrated in FIG. 1) imaging units 15a, 15b, 15c, 15d. The imaging units 15a to 15d are attached to the vehicle 1 to capture images of areas including road surfaces of surroundings of the vehicle 1.

According to an example shown in FIG. 1, the imaging unit 15a is provided at a rear-end portion 2e of a body 2 (for example, at a rear bumper), and captures images of the areas including road surfaces of the rear of the vehicle 1. The imaging unit 15b is provided at a door mirror 2g of a right-end portion 2f of the body 2, and captures images of the areas including road surfaces of the right side of the vehicle 1. The imaging unit 15c is provided at a front-end portion 2c of the body 2 (for example, at a front bumper), and captures images of the areas including road surfaces of front of the vehicle 1. The imaging unit 15d is provided at a door mirror 2g of a left end portion 2d of the body 2, and captures images of the areas including road surfaces of the left side of the vehicle 1.

To simplify the description, the imaging units 15a to 15d may be described as an imaging unit 15 in a case where the imaging units 15a to 15d are not necessarily identified from one another.

The imaging unit 15 is a so-called digital camera including an image device or image sensor such as a charge-coupled device or CCD, and a complementary metal-oxide semiconductor image sensor or CMOS image sensor or CIS. The imaging unit 15 captures images of surroundings of the vehicle 1 at a predetermined frame rate, and outputs image data of the captured image obtained by the capturing operation or imaging operation. The image data obtained by the imaging unit 15 may include dynamic image as a frame image.

The technology for helping the passenger monitor surroundings of the vehicle 1 by outputting the captured image captured by the imaging unit 15 to help the passenger of the vehicle 1 visually confirm the captured image has been known. Such a technology may not appropriately help the passenger monitor surroundings of the vehicle 1 if outputting the captured image without any process in a case where the captured image includes stained areas caused by water drops, dusts, and dirt adhered to the optical system (such as a lens) of the imaging unit 15.

Therefore, a technology for generating restored images restored from the captured image to reduce the stained areas has been considered. Such a technology generally reduces all the stained areas by equal degrees regardless of the orientations or positions of the stained areas in the captured image.

However, it is not efficient to remove the stained areas where the necessity of visual confirmation by the passenger is low by an equivalent amount of the area where the necessity of visual confirmation by the passenger is high.

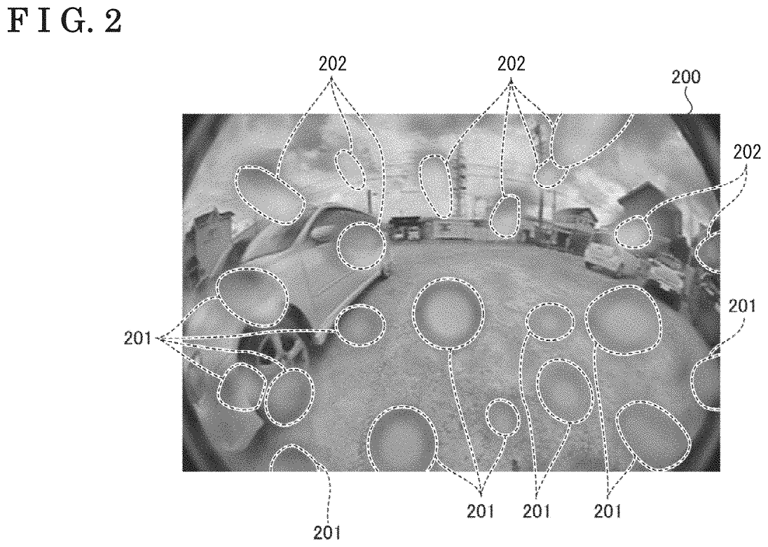

For example, as shown in an example in FIG. 2, an image 200 serving as a captured image includes plural stained areas 201 caused by water drops adhered to the optical system of the imaging unit 15. The stained areas 201 are included in various positions in the image 200 to cover various subjects such as road surfaces, vehicles on the road surfaces, objects such as architectures and sky which are captured in the image 200.

Assuming a case where the image 200 is used as a means to check surroundings when the vehicle 1 is parking (or leaving the parking area) or moving, areas where the necessity of visual confirmation by the passenger is high are mainly areas where road surfaces or objects on the road surfaces are captured in the image 200, and other areas, such as an area including sky, are supposed to be the areas where the necessity of visual confirmation by the passenger is low. In this case, it is efficient that the stained areas 201 included in the areas (positions) captured with the road surfaces or the objects on the road surfaces are reduced by higher degree than stained areas 202 included in the other areas (positions).

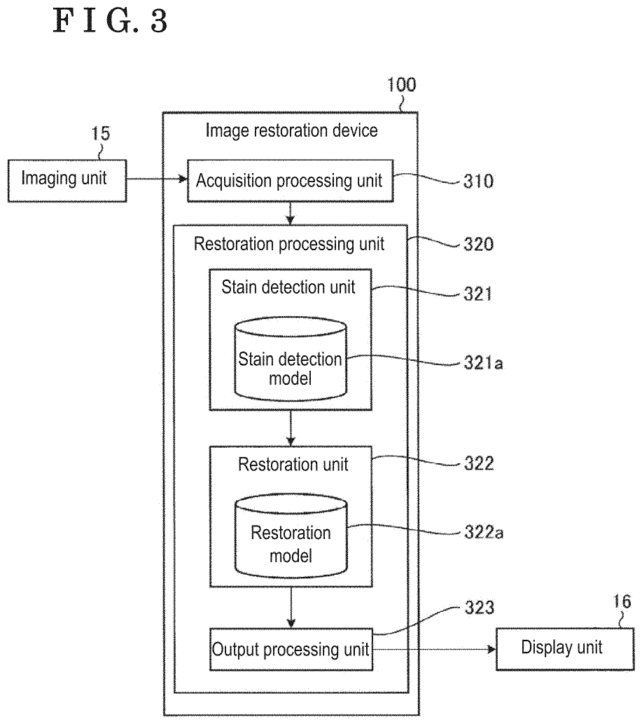

Here, in the embodiment, the image restoration device 100 efficiently reduces the stained areas by including functions shown in FIG. 3.

As shown in FIG. 3, the image restoration device 100 of the embodiment includes an acquisition processing unit 310 and a restoration processing unit 320.

The acquisition processing unit 310 acquires the captured image from the imaging unit 15.

In a case where the captured image acquired by the acquisition processing unit 310 includes the stained areas caused by stains of the optical system of the imaging unit 15, the restoration processing unit 320 generates a restored image restored by the captured image, and outputs the captured image which is generated thereby to the display unit 16. The restored image is generated in a case where a predetermined starting condition is achieved, the predetermined starting condition, for example, where the passenger performs a predetermined operation for requesting the restoration of the captured image. The display unit 16 configured to output the restored image is, for example, a monitor, for monitoring surroundings, attached to a dashboard of the vehicle 1.

In the embodiment, the restoration processing unit 320 includes a stain detection unit 321, a restoration unit 322, and an output processing unit 323. The restoration processing unit 320 outputs restored images in which the stained images are reduced efficiently in different degrees in accordance with the positions thereof in the captured image.

The stain detection unit 321 determines whether the captured image includes the stained areas by detecting the possibility of the existence of the stained areas in each area of the captured image (the size may be one pixel or plural pixels). More concretely, based on a stain detection model 321a, the stain detection unit 321 detects whether the captured image includes the stained areas, or more specifically, detects stain data which relates to positions and sizes (dimensions) of the stained areas included in the captured image. The stain detection model 321a corresponds to a neural network which is pre-trained by a machine learning method to output the possibility of the existence of the stained area in the captured image as a numeral number of, for example, 0 to 1.

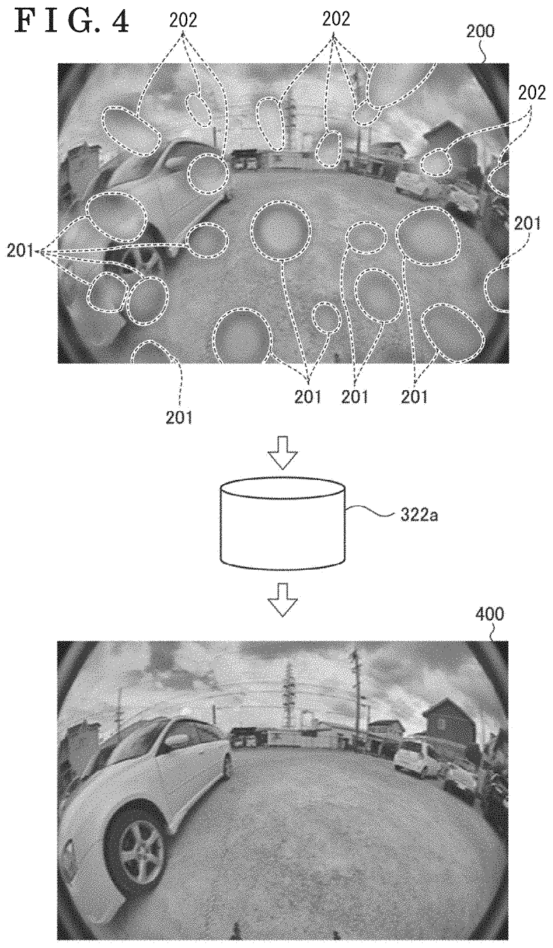

In a case where the captured image acquired by the acquisition processing unit 310 includes the stained areas caused by the stains of the optical system of the imaging unit 15, the restoration unit 322 outputs the restored image corresponding to the captured image acquired by the acquisition processing unit 310 based on a restoration model 322a. The restoration model 322a corresponds to a neural network which is pre-trained by the machine learning method to output the restored image in response to the input of the captured image, for example, as shown in FIG. 4.

As shown in FIG. 4, the restoration model 322a is configured to output an image 400 as a restored image in accordance with the input of the image 200 serving as the captured image shown in FIG. 2, the restored image in which the stained areas 201 included in the image 200 are reduced.

However, as described above, it is not efficient to remove all the stained areas included in the inputted captured image equally. Accordingly, in the embodiment, the restoration model 322a is configured to output the restored image in which the stained areas are reduced in different degrees in accordance with the positions of the stained areas in the captured image.

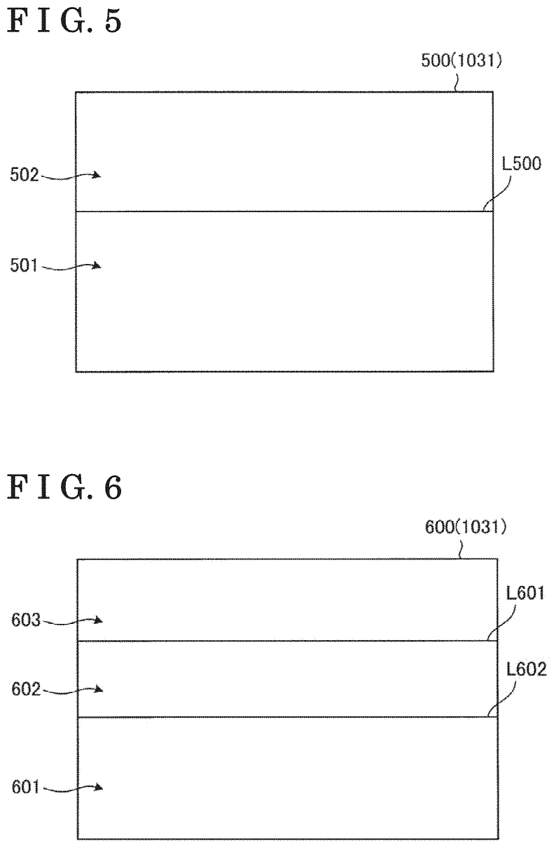

For example, as shown in FIG. 5, the restoration model 322a is configured to output the restored image in which the stained areas included in a predetermined area are reduced in a larger degree than the stained areas included in the other area, the predetermined area serving as an area where the necessity of visual confirmation by the passenger is high in the captured image.

As shown in an example in FIG. 5, an area 500 is divided into two areas 501, 502 by a divisional line L500 which is arranged at a predetermined position. Assuming that the area 500 corresponds to a captured image, the area 501 is considered to mainly include a road surface and objects on the road surface since the area 501 corresponds to a lower side of the area 500. On the other hand, assuming that the area 500 corresponds to the captured image, the area 502 is considered to mainly include sky since the area 502 corresponds to an upper side of the area 500.

As described above, in a case where the captured image is used as a method of confirming surroundings when the vehicle 1 is parking, leaving the parking area, and moving, the area where the necessity of visual confirmation by the passenger is high may be the area where the road surface or the objects thereon are included, and the other areas may be the areas where the necessity of visual confirmation by the passenger is low. Accordingly, as shown in the example in FIG. 5, in a case where the stained areas are included in both two areas in the captured image, the two areas corresponding to the area 501 and the area 502, the stained areas may be efficiently removed by reducing the stained areas included in the area corresponding to the area 501 in a larger degree than the stained areas included in the area corresponding to the area 502.

Thus, as shown in the example in FIG. 5, in a case where the degree to reduce the stained areas is expressed as a restoration degree, the restoration degree allocated to the area 501 is set or specified larger than the restoration degree allocated to the area 502. In a case where the captured image (corresponding to the area 500) is inputted, the restoration model 322a is configured to output the restored image in which the stained areas included in the lower area (corresponding to the area 501) is reduced in a larger degree than the stained areas included in the upper area (corresponding to the area 502) of the captured image.

In the aforementioned example, the restoration model 322a is configured based on the conception that the area 500 corresponding to the captured image is divided into two areas corresponding to the area 501 and the area 502. However, in the embodiment, as shown in another example in FIG. 6, the restoration model 322a may be configured based on the conception that an area 600 corresponding to the captured image is divided into three areas which are an area 601, an area 602, and an area 603.

As shown in the example in FIG. 6, the area 600 is divided into three areas which are the areas 601 to 603 by a first divisional line L601 and a second divisional L602. Since the area 601 is oriented at the lowermost position of the area 600, the area 601 is considered to mainly include a road surface in a case where the area 600 corresponds to the captured image. Since the area 602 is oriented at the middle position of the area 600 in the upper-lower direction, the area 602 is considered to mainly include objects on the road surface in a case where the area 600 corresponds to the captured image. Since the area 603 is oriented at the uppermost position of the area 600, the area 602 is considered to mainly include sky in a case where the area 600 corresponds to the captured image.

When the vehicle 1 is moving, it is especially important for the passenger to monitor objects on the road surface. Thus, as shown in the example in FIG. 6, in a case where the three areas of the captured image corresponding to the areas 601 to 603 all include stained areas, the stained areas may be considered to be efficiently reduced if the stained areas included in the area corresponding to the area 602 in the captured image are reduced by the largest degree in a case where the captured image is used as a method of the surroundings confirmation when the vehicle 1 is moving.

Accordingly, as shown in the example in FIG. 6, the restoration degree allocated to the area 602 which is oriented or arranged at the middle of the area 600 in the upper-lower direction is specified or set larger than the restoration degrees allocated to the area 601 and the area 602. In this case, the restoration model 322a is configured to output the restored image in which the stained areas included at the middle of the captured image in the upper-lower direction (corresponding to the area 602) are reduced in a larger degree than the stained areas included in the other areas (corresponding to the area 601 and the area 603) in a case where the captured image (corresponding to the area 600) is inputted.

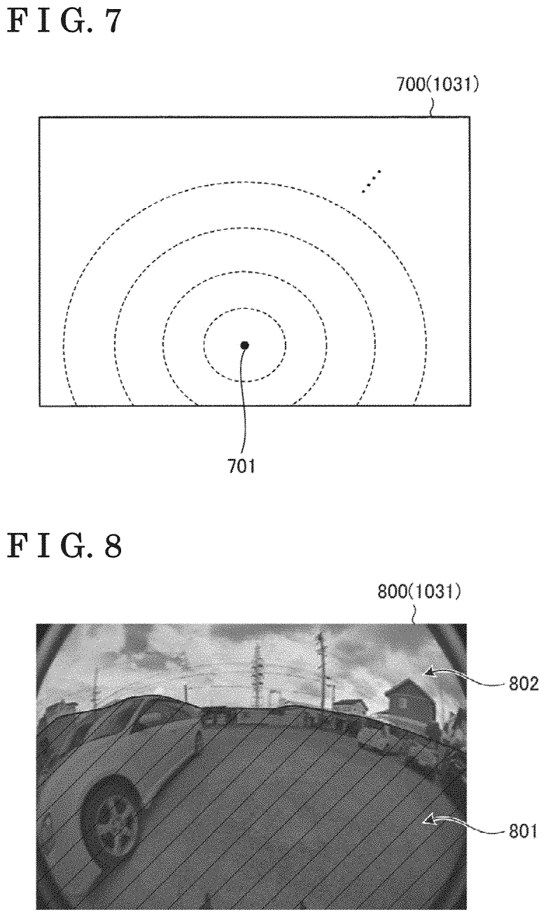

In the aforementioned two examples explained with reference to FIGS. 5 and 6, the restoration model 322a is configured to reduce the stained areas in different degrees by each of the areas being divided. However, in the embodiment, as another example, the restoration model 322a is considered to be configured to reduce the stained areas in different degree by each of the positions (for example, per 1 pixel) as shown in FIG. 7.

As shown in an example in FIG. 7, a position 701 which is oriented at a lower-middle position in the right-left direction is allocated with the largest restoration degree, and the other positions are allocated with restoration degrees which conform to the normal distribution having the restoration degree allocated to the position 701 as a peak. In a case where the captured image (corresponding to the area 700) is inputted, the restoration model 322a is configured to output the restored image in which the stained areas included in the lower middle position in the right-left direction (corresponding to the position 701) are reduced in a larger degree than the stained areas included in the other positions.

The lower-middle position of the captured image in the right-left direction is considered to be the most remarkable or noticeable position for the passenger of the vehicle 1. By allocating the restoration degree as the example shown in FIG. 7, the stained areas may be efficiently reduced by position.

The allocation of the restoration degree in accordance with the area (position) is fixed in the aforementioned three examples explained with reference to FIGS. 5 to 7. That is, according to the aforementioned three examples, the shape and the dimension (size) of the area (position) to be allocated with, for example, the largest restoration degree, are fixed and are not changed. However, in the embodiment, as shown in FIG. 8, the correspondence or the corresponding relationship between the area (position) of the captured image and the reduction degree allocated to the area (position) may be configured to be changed in accordance with the captured image.

In an example shown in FIG. 8 illustrating an area 800 corresponding to the captured image, the restoration degree allocated to an area 801 which corresponds to the area including the road surface and objects close to the road surface in the captured image is specified or set larger than the restoration degree allocated to an area 802 which corresponds to the other area in the captured image. In a case where the captured image (corresponding to the area 800) is inputted, the restoration model 322a is configured to output the restored image in which the stained areas included in the area where the road surface or objects close to the road surface are included (corresponding to the area 801) are reduced in a larger degree than the stained areas included in the other area (corresponding to the area 802).

Here, in the example shown in FIG. 8, the area 800 corresponding to the captured image is classified based on a classification result of the captured image by a predetermined classifier. The predetermined classifier corresponds to, for example, a neural network pre-trained by the machine learning method to classify the captured image into plural areas in accordance with captured subjects, for example, the road surface. Thus, as shown in the example shown in FIG. 8, the classification is different from the fixed classifications of the examples in FIGS. 5 to 7. Classification of the example shown in FIG. 8 changes in response to or in accordance with how the subjects in the captured image are captured, and accordingly, the restoration degree may be flexibly allocated in accordance with the areas.

The allocation of the restoration degrees of the examples shown in FIGS. 5 to 8 relates to an importance map 1031 used when generating the restoration model 322a.

As such, in the embodiment, in a case where the captured image includes the stained areas, the restoration model 322a is pre-trained by the machine learning method to output the restored image in which the stained areas are reduced in different degrees in accordance with the positions of the stained areas in the captured image, that is, are reduced based on the allocation of the restoration degree shown in the examples in FIGS. 5 to 8.

Back to FIG. 1, the output processing unit 323 outputs the restored image generated by the restoration unit 322 to the display unit 16. The restored image is no longer outputted in a case where a predetermined restoration termination condition is accomplished, the predetermined restoration termination condition, for example, where the passenger of the vehicle 1 operates a predetermined operation for requesting the termination of the restoration of the captured image.

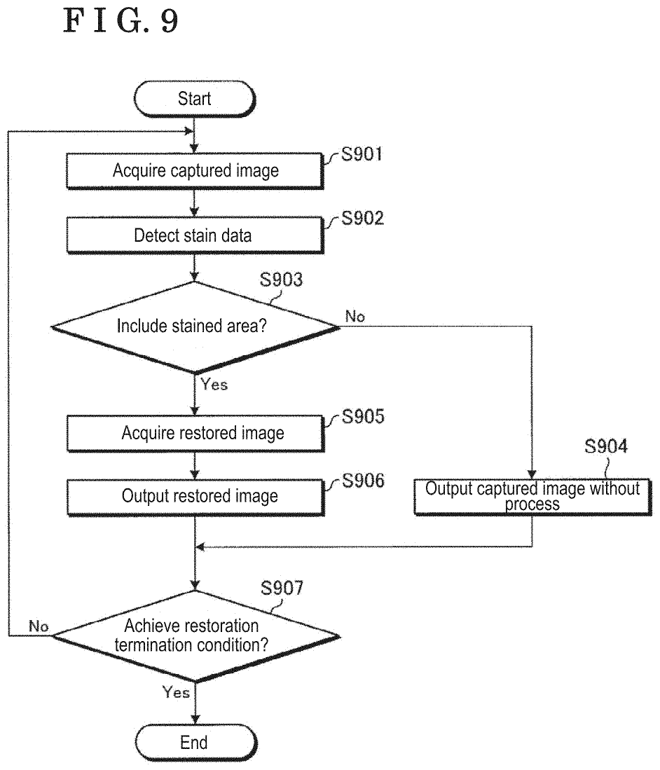

Based on the aforementioned configuration, the image restoration device 100 of the embodiment operates or executes a series of processes as shown in FIG. 9 to restore the captured image in response to the accomplishment of an aforementioned restoration starting condition which serves as a condition where the monitoring of the surroundings of the vehicle 1 is started by using the restored image.

As shown in FIG. 9, in the embodiment, in Step S901, the acquisition processing unit 310 of the image restoration device 100 acquires the captured image captured by the imaging unit 15.

In Step S902, the stain detection unit 321 of the image restoration device 100 inputs the captured image acquired in Step S901 to the stain detection model 321a, and acquires stain data outputted by the stain detection model 321a. The stain data relates to positions and sizes (dimensions) of the stained areas.

In Step S903, the stain detection unit 321 of the image restoration device 100 determines whether the captured image acquired in Step S901 includes the stained areas based on the stain data acquired in Step S902.

In a case where it is determined that the captured image does not include the stained areas in Step S903, the process goes to Step S904. In Step S904, the output processing unit 323 of the image restoration device 100 outputs the captured image without processing to the display unit 16. Then, the process goes to Step S907.

On the other hand, in a case where the captured image includes the stained areas, the process goes to Step S905. In Step S905, the restoration unit 322 of the image restoration device 100 inputs the captured image acquired in Step S901 to the restoration model 322a, and acquires the restored image outputted by the restoration model 322a. The acquired restored image corresponds to the restored image in which the stained areas are reduced in different degrees in accordance with the positions thereof in the captured image.

In Step S906, the output processing unit 323 of the image restoration device 100 outputs the restored image acquired in Step S905 to the display unit 16.

In Step S907, the image restoration device 100 determines whether the aforementioned restoration termination condition is achieved as a condition for terminating the monitoring of surroundings of the vehicle 1 using the restored image.

In Step S907, in a case where the restoration termination condition is determined not to be achieved, surroundings of the vehicle 1 is required to be continuously monitored using the restored image. In this case, the process goes back to Step S901.

On the other hand, in a case where the restoration termination condition is determined to be achieved in Step S907, the monitoring of surroundings of the vehicle 1 using the restored image is required to be terminated. In this case, the process is terminated.

As explained above, the image restoration device 100 of the embodiment includes the acquisition processing unit 310 and the restoration processing unit 320. The acquisition processing unit 310 acquires the captured image acquired by the imaging unit 15 which captures the images of the surroundings of the vehicle 1. In a case where the captured image includes the stained areas caused by the stains of the optical system of the imaging unit 15, the restoration processing unit 320 outputs the restored image corresponding to the captured image acquired by the acquisition processing unit 310 based on the restoration model 322a pre-trained by the machine learning method to output the restored image in response to the input of the captured image, the restored image serving as a captured image in which the stained areas are reduced in different degrees in accordance with the positions of the stained areas in the captured image.

According to the image restoration device 100 of the embodiment, the stained areas are reduced in different degrees in accordance with the positions of the stained areas in the captured image instead of being reduced equally regardless of the positions of the stained areas in the captured image. Accordingly, the stained areas may be effectively reduced.

For example, in the embodiment, the restoration model 322a may be configured to output the restored image in which the stained areas included at predetermined areas serving as positions where the necessity of visual recognition by the passenger of the vehicle 1 is high in the captured image are reduced in a larger degree than the stained areas included in other positions (see FIG. 7). In this configuration, the stained areas may be reduced more efficiently and more in detail by the restoration model 322a in which the degree to reduce the stained areas is specifically adjusted by unit of positions.

In the embodiment, the restoration model 322a may be configured to output the restored image in which the stained areas included at predetermined areas serving as areas where the necessity of visual recognition by the passenger of the vehicle 1 is high in the captured image are reduced in a larger degree than the stained areas included in other areas (see FIGS. 5 and 6). In this configuration, the stained areas may be reduced more efficiently and more easily by the restoration model 322a in which the degree to reduce the stained areas is roughly adjusted by unit of areas.

In the embodiment, the restoration model 322a may be configured to output the restored image in which the stained areas are reduced in different degrees by each of the plural areas corresponding to the classification result in which the captured image is classified by the predetermined classifier in accordance with the subjects captured in the captured image (see FIG. 8). In this configuration, the stained areas may be reduced more efficiently and more flexibly by the restoration model 322a in which the degree to reduce the stained areas may change in accordance with the positions of the stained areas in the captured image in accordance with the subjects captured in the captured image.

A restoration model generation device 1000 for generating the aforementioned restoration model 322a will hereunder be explained.

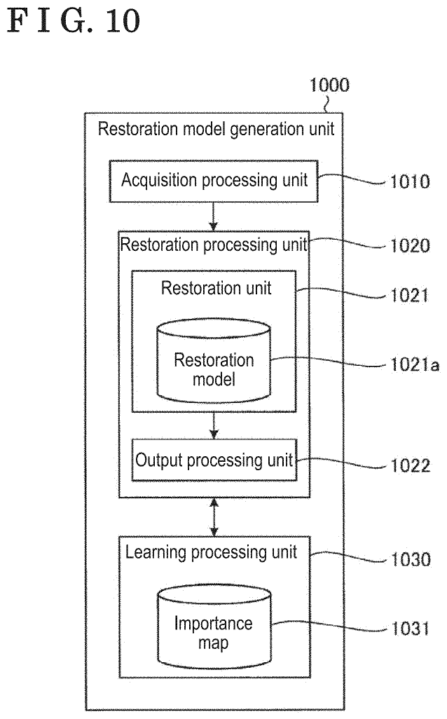

As shown in FIG. 10, the restoration model generation device 1000 includes an acquisition processing unit 1010, a restoration processing unit 1020, and a learning processing unit 1030.

The acquisition processing unit 1010 acquires the captured image including the stained areas as a sample used for the machine learning method. The acquisition processing unit 1010 may acquire the captured image including the stained areas, and an ideal image as an ideal captured image in which the stained areas are (completely) removed.

The restoration processing unit 1020 includes a restoration operation unit 1021 and an output processing unit 1022.

The restoration operation unit 1021 acquires the restored image corresponding to the captured image acquired by the acquisition processing unit 1010 based on a restoration model 1021a outputting the restored image in response to the input of the captured image, the restored image serving as a captured image in which the stained areas are reduced. The output processing unit 1022 outputs the restored image acquired by the restoration operation unit 1021 to the learning processing unit 1030.

The restoration model 1021a is a neural network corresponding to the restoration model 322a (see FIG. 3) before the machine learning method is completed.

The learning processing unit 1030 trains the restoration model 1021a by the machine learning method to obtain the aforementioned restoration model 322a (see FIG. 3) which outputs a restored image in response to the input of the captured image, the restored image serving as the captured image in which the stained areas are reduced in different degrees in accordance with the positions thereof in the captured image.

Basically, the learning processing unit 1030 calculates a difference as a loss, the difference between the restored image outputted by the restoration processing unit 1020 and an ideal image as a captured image in which the stained areas are removed by each position or each predetermined area. The learning processing unit 1030 then adjusts parameters such as the weighting of the restoration processing unit 1020a to reduce the loss close to zero.

However, if the loss of all positions in the image is equally handled or calculated, all the stained areas are reduced by the equal degrees regardless of the positions of the stained areas in the captured image. Accordingly, the aforementioned restoration model 322a (see FIG. 3) which may reduce the stained areas efficiently cannot be obtained.

Thus, in the embodiment, the learning processing unit 1030 operates the machine learning method based on the restored image, the ideal image, and the importance map 1031, the restored image outputted by the restoration processing unit 1020, the ideal image serving as the captured image in which the stained areas are removed, and the importance map 1031 indicating the correspondence or the corresponding relationship between any positions in the captured image and the restoration degree indicating the degree to reduce the stained areas.

That is, the learning processing unit 1030 corrects the loss in accordance with the restoration degree of the learning processing unit 1030, the loss which corresponds to the difference between the restored image outputted by the restoration processing unit 1020 and the ideal image as the captured image in which the stained areas are removed. Then, the learning processing unit 1030 trains the restoration model 1021a by the machine learning method to reduce the loss after correction. For example, if the learning processing unit 1030 trains the restoration model 1021a to correct the loss of the certain areas (positions) larger than the other areas (positions), the restoration model 1021a which reduces the stained areas of the certain area (position) more intensively than the other areas may be obtained.

Here, it is reasonable that the training of the restoration model 1021a for achieving the restoration of the examples shown in FIGS. 5 to 7 is executed by using the predetermined importance map 1031.

More specifically, it is reasonable that the training of the restoration model 1021a for achieving the restoration of the example shown in FIG. 5 is executed based on the importance map 1031 in which the restoration degree is preset by area, the restoration degree serving as a correction coefficient to increase the loss of the areas where the road surface and the objects on the road surface are seemed to be mainly captured (see the region 501 in FIG. 5) more than the loss of the areas where sky is seemed to be mainly captured (see the region 502 in FIG. 5).

Similarly, it is reasonable that the training of the restoration model 1021a for achieving the restoration of the example shown in FIG. 6 is executed based on the importance map 1031 in which the restoration degree is preset by area, the restoration degree serving as a correction coefficient to increase the loss of the areas where the objects on the road surface are seemed to be mainly captured (see the region 602 in FIG. 6) more than the loss of the other areas (see the regions 601, 603 in FIG. 6).

Furthermore, it is reasonable that the training of the restoration model 1021a for achieving the restoration of the example shown in FIG. 7 is executed based on the importance map 1031 in which the restoration degree as the correction coefficient is preset to increase the loss of the position where the passenger of the vehicle 1 should most watch (see the position 701 in FIG. 7).

As such, in the embodiment, the various restoration models 322a may be generated by using the importance map 1031 in which the appropriate restoration degree is preset or predetermined by area (position) in accordance with which areas (positions) where the stained areas are included are required to be intensively removed.

On the other hand, it is reasonable that the training of the restoration model 1021a for achieving the restoration of the example shown in FIG. 8 is executed by using the importance map 1031 which dynamically or flexibly changes in accordance with how the subjects of the captured image (restored image) are captured instead of the predetermined importance map 1031.

More specifically, it is reasonable that the importance map 1031 used for the training of the restoration model 1021a to achieve the restoration of the example shown in FIG. 8 is generated dynamically or flexibly, in response to the output of the restored image by the restoration processing unit 1020, by setting different restoration degrees by each of plural areas after the predetermined classifier classifies the restored image into the plural areas in accordance with the subjects captured in the restored image. The predetermined classifier corresponds to the neural network pre-trained by the machine learning method to classify the captured image into the plural areas in accordance with the captured subjects such as the road surface.

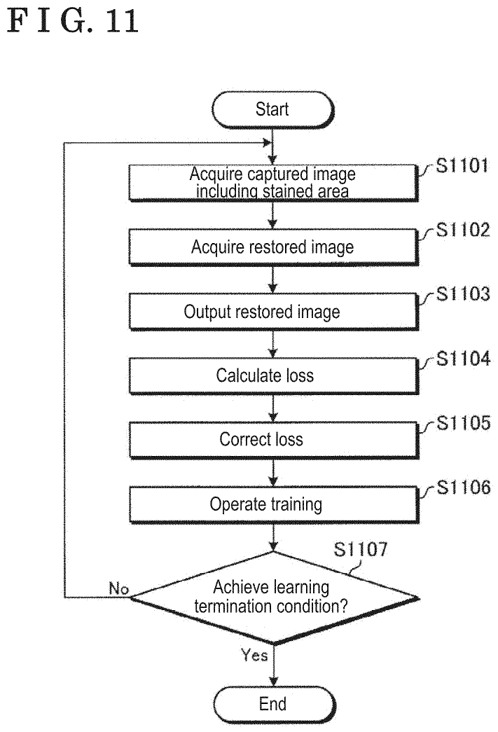

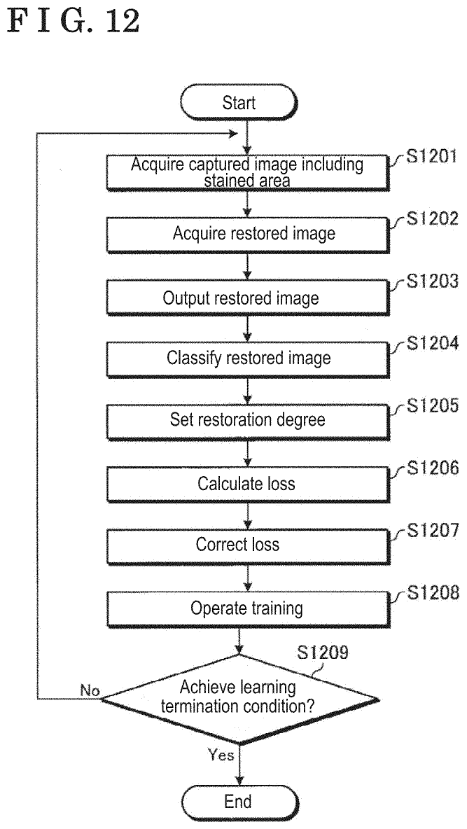

Based on above, the restoration model generation device 1000 of the embodiment generates the restoration model 322a (see FIG. 3) which may output the restored image in response to the input of the captured image, the restored image in which the stained areas are reduced in different degrees in accordance with the positions thereof in the captured image by a series of processes shown in FIGS. 11 and 12.

The flowchart shown in FIG. 11 corresponds to a series of processes executed for the training of the restoration model 1021a to achieve the restoration of the examples shown in FIGS. 5 to 7.

As shown in FIG. 11, in Step S1101 of the embodiment, an acquisition processing unit 1010 of the restoration model generation device 1000 acquires the captured image including the stained areas as a sample used in the machine learning method.

In Step S1102, the restoration operation unit 1021 of the restoration model generation device 1000 inputs the captured image acquired in S1101 to the restoration model 1021a and acquires the restored image outputted by the restoration model 1021a.

In Step S1103, the output processing unit 1022 of the restoration model generation device 1000 outputs the restored image acquired in S1102 to the learning processing unit 1030.

In Step S1104, the learning processing unit 1030 of the restoration model generation device 1000 calculates the loss as the difference between the restored image outputted in S1103 and an ideal image serving as a captured image in which the stained areas are (completely) removed.

In Step S1105, the learning processing unit 1030 of the restoration model generation device 1000 corrects the loss calculated in S1104 in accordance with the restoration degree defined by the importance map 1031.

In Step S 1106, the learning processing unit 1030 of the restoration model generation device 1000 trains the restoration model 1021a by the machine learning method to decrease the loss corrected in S1105.

In Step S1107, the learning processing unit 1030 of the restoration model generation device 1000 determines whether the learning termination condition serving as a condition to terminate the training of the restoration model 1020a is accomplished or not. The learning termination condition is achieved in a case where, for example, the loss is decreased to equal to or less than a predetermined amount.

In Step S1107, in a case where the learning termination condition is determined not to be achieved, the learning processing unit 1030 may determine that the training of the restoration model 1020a is required to be continued. In this case, the operation goes back to S1101.

On the other hand, in a case where the learning termination condition is determined to be achieved in S1107, the learning processing unit 1030 may determine that no further training of the restoration model 1021a is necessary. In this case the operation is terminated.

FIG. 12 is an exemplified example of a flowchart illustrating a series of processes executed by the restoration model generation device 1000 to generate the restoration model 322a (see FIG. 3) in a case where the importance map 1031 of the embodiment is not predetermined. That is, the flowchart shown in FIG. 12 corresponds to a series of processes executed for the training of the restoration model 1021a to achieve the restoration of the example shown in FIG. 8.

As shown in FIG. 12, in the embodiment, in Step S1201, the acquisition processing unit 1010 of the restoration model generation device 1000 acquires the captured image including the stained areas as a sample used in the machine learning method.

In Step S1202, the restoration operation unit 1021 of the restoration model generation device 1000 inputs the captured image acquired in S1201 to the restoration model 1021a, and acquires the restored image outputted by the restoration model 1021a.

In Step S1203, the output processing unit 1022 of the restoration model generation device 1000 outputs the restored image acquired in S1202 to the learning processing unit 1030.

In Step S1204, the learning processing unit 1030 of the restoration model generation device 1000 classifies (divides) the restored image outputted in S1203 by the predetermined classifier in accordance with the captured subjects.

In Step S1205, the learning processing unit 1030 of the restoration model generation device 1000 sets a desired restoration degree of the areas classified as the classification result in S1204, and generates the appropriate importance map 1031 to use for the correction in S1207. The restoration degree may be set or specified manually by an operator of the restoration model generation device 1000, or automatically based on a predetermined rule.

In Step S1206, the learning processing unit 1030 of the restoration model generation device 1000 calculates the loss which corresponds to the difference between the restored image outputted in S1203 and the ideal image serving as a captured image in which the stained areas are (completely) removed.

In Step S1207, the learning processing unit 1030 of the restoration model generation device 1000 corrects the loss calculated in S1206 in accordance with the restoration degree defined by the importance map 1031 generated in accordance with the setting in S1205.

In Step S1208, the learning processing unit 1030 of the restoration model generation device 1000 trains the restoration model 1021a by the machine learning method to decrease the loss corrected in S1207.

In Step S1209, the learning processing unit 1030 of the restoration model generation device 1000 determines whether the learning termination condition as a condition to terminate the training of the restoration model 1021a is achieved or not.

In a case where the learning termination condition is not achieved in S1209, the process goes back to S1201. On the other hand, in a case where the learning termination condition is achieved in S1209, the process is terminated.

The restoration model 1021a after the training based on a series of processes shown in FIGS. 11 and 12 is mounted on the image restoration device 100 (see FIG. 3), and functions as the restoration model 322a (see FIG. 3).

As explained above, the restoration model generation device 1000 of the embodiment includes the acquisition processing unit 1010, the restoration processing unit 1020, and the learning processing unit 1030. The acquisition processing unit 1010 acquires the captured image obtained by the imaging unit 15 capturing the surroundings of the vehicle 1 and the captured image including the stained areas caused by the stains of the optical system of the imaging unit 15. The restoration processing unit 1020 outputs the restored image corresponding to the captured image acquired by the acquisition processing unit 1010 based on the restoration model 1021a outputting the restored image in response to the input of the captured image, the restored image serving as the captured image in which the stained areas are reduced. The learning processing unit 1030 trains the restoration model 1021a to output the restored image in response to the input of the captured image, the restored image as the captured image in which the stained areas are reduced in different degrees in accordance with the positions in the captured image by the machine learning method based on the restored image outputted by the restoration processing unit 1020, the ideal image serving as the captured image in which the stained areas are (completely) removed, and the importance map 1031 indicating the correspondence between any positions in the captured image and the restoration degree indicating the degree to reduce the stained areas.

According to the restoration model generation device 1000 of the embodiment, the restoration model 322a (see FIG. 3) may be appropriately generated, the restoration model 322a which may reduce the stained areas in different degrees in accordance with the positions thereof in the captured image to establish the image restoration device 100 that may reduce the stained areas more efficiently by the appropriate training of the restoration model 1020a by the machine learning method.

Here, in the embodiment, the importance map 1031 may be a predetermined map. The learning processing unit 1030 corrects the difference between the restored image and the ideal image by each of the positions, and trains the restoration model 1020a by the machine learning method to decrease the difference after the correction. The restoration model 1021a may be easily trained by using the predetermined importance map 1031.

In this case, for example, the restoration degree of the importance map 1031 may be specified or set to correct the difference between the restored image and the ideal image more largely at the predetermined positions where the necessity of visual confirmation by the passenger is high in the captured image (see FIG. 7). According to the configuration, the restoration model 1021a may be easily trained to obtain the restoration model 322a (see FIG. 3) which may more efficiently and specifically reduce the stained areas.

The restoration degree of the importance map 1031 may be set or specified to correct the difference between the restored image and the ideal image more largely at the predetermined areas where the necessity of visual confirmation by the passenger of the vehicle 1 is high in the captured image (see FIGS. 5 and 6). According to the configuration, the restoration model 1021a may be easily trained to obtain the restoration model 322a (see FIG. 3) which may more efficiently and easily reduce the stained areas.

In the embodiment, the learning processing unit 1030 may classify the restored images into the plural areas in accordance with the subjects captured in the restored image by the predetermined classifier, and generate the importance map 1031 by specifying or setting the different restoration degrees by each of the plural areas. According to the configuration, the restoration model 1021a may be easily trained to obtain the restoration model 322a (see FIG. 3) which may more efficiently and flexibly reduce the stained areas.

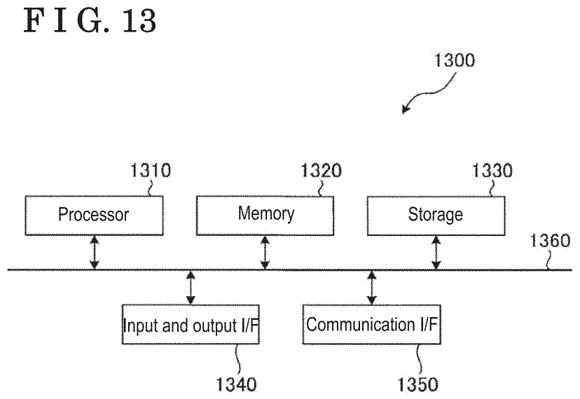

The image restoration device 100 and the restoration model generation device 1000 of the embodiment correspond to an information processing unit 1300 including the same hardware configuration as a general computer, for example, as shown in FIG. 13.

As shown in FIG. 13, the information processing unit 1300 of the embodiment includes a processor 1310, a memory 1320, a storage 1330, an input-output interface (I/F) 1340, and a communication interface (I/F) 1350. These hardware components are connected to a bus 1360.

The processor 1310 is configured as, for example, a Central Processing Unit or CPU, and entirely controls the operation of each unit of the information processing unit 1300.

The memory 1320 includes a Read Only Memory or ROM, and a Random Access Memory or RAM, memorizes data volatilely or non-volatilely such as a program executed by the processor 1310, and provides a workspace for the processor 1310 to operate the program.

The storage 1330 includes, for example, a Hard Disk Drive or HDD or a Solid State Drive or SDD, and memorizes data non-volatilely.

The input-output interface 1340 controls the input of the data to the information processing unit 1300 and the output of the data from the information processing unit 1300.

The communication interface 1350 makes the information processing unit 1300 communicate with other devices.

In the embodiment, functional modules included by the image restoration device 100 shown in FIG. 3 are established by the cooperation of the hardware and the software as a result of that the processor 1310 of the information processing unit 1300 serving as the image restoration device 100 executes the predetermined computer programs memorized, for example, in the memory 1320 or the storage 1330. However, in the embodiment, at least a part of the functional modules shown in FIG. 3 may be established by a dedicated hardware (circuit: circuitry).

Similarly, in the embodiment, the functional modules included by the restoration model generation device 1000 shown in FIG. 10 are established by the cooperation of the hardware and the software of the information processing unit 1300 serving as the restoration model generation device 1000. However, in the embodiment, at least a part of the functional modules shown in FIG. 10 may be established by a dedicated hardware (circuit: circuitry).

The computer programs executed by the information processing unit 1300 of the embodiment may be provided in a state of being pre-mounted on a memory device such as the memory 1320 or the storage 1330. Alternatively, the computer programs may be provided as a computer program product memorized in a computer-readable memory medium, by an installable mode or an operable mode, such as any kinds of magnetized disk, for example, a flexible disk or FD, or any kinds of a laser disk, for example, a Digital Versatile Disk or DVD.

The computer programs executed by the information processing unit 1300 of the embodiment may be provided or distributed via a network such as internet. That is, the computer programs executed by the information processing unit 1300 of the embodiment may be provided by being downloaded via a network from a computer in a state of being stored on the computer connected to a network such as internet.

According to the disclosure, the image restoration device 100 includes the acquisition processing unit 310 and the restoration processing unit 320. The acquisition processing unit 310 acquires the captured image acquired by the imaging unit 15 which captures the images of the surroundings of the vehicle 1. In a case where the captured image includes the stained areas caused by the stains of the optical system of the imaging unit 15, the restoration processing unit 320 outputs the restored image corresponding to the captured image acquired by the acquisition processing unit 310 based on the restoration model 322a pre-trained by the machine learning method to output the restored image in response to the input of the captured image, the restored image serving as a captured image in which the stained areas are reduced in different degrees in accordance with the positions of the stained areas in the captured image.

According to the image restoration device 100, the stained areas are reduced in different degrees in accordance with the positions of the stained areas in the captured image instead of being reduced equally regardless of the positions of the stained areas in the captured image. Accordingly, the stained areas may be effectively reduced.

According to the disclosure, the restoration model 322a is configured to output the restored image in which the stained areas included at predetermined areas serving as positions where the necessity of visual recognition by the passenger of the vehicle 1 is high in the captured image are reduced in a larger degree than the stained areas included in other positions.

In this configuration, the stained areas may be reduced more efficiently and more in detail by the restoration model 322a in which the degree to reduce the stained areas is specifically adjusted by unit of positions.

According to the disclosure, the restoration model 322a is configured to output the restored image in which the stained areas included at predetermined areas serving as areas where the necessity of visual recognition by the passenger of the vehicle 1 is high in the captured image are reduced in a larger degree than the stained areas included in other areas.

In this configuration, the stained areas may be reduced more efficiently and more easily by the restoration model 322a in which the degree to reduce the stained areas is roughly adjusted by unit of areas.

According to the disclosure, the restoration model 322a is configured to output the restored image in which the stained areas are reduced in different degrees by each of the plural areas corresponding to the classification result in which the captured image is classified by the predetermined classifier in accordance with the subjects captured in the captured image.

In this configuration, the stained areas may be reduced more efficiently and more flexibly by the restoration model 322a in which the degree to reduce the stained areas may change in accordance with the positions of the stained areas in the captured image in accordance with the subjects captured in the captured image.

According to the disclosure, the restoration model generation device 1000 includes the acquisition processing unit 1010, the restoration processing unit 1020, and the learning processing unit 1030. The acquisition processing unit 1010 acquires the captured image obtained by the imaging unit 15 capturing the surroundings of the vehicle 1 and the captured image including the stained areas caused by the stains of the optical system of the imaging unit 15. The restoration processing unit 1020 outputs the restored image corresponding to the captured image acquired by the acquisition processing unit 1010 based on the restoration model 1021a outputting the restored image in response to the input of the captured image, the restored image serving as the captured image in which the stained areas are reduced. The learning processing unit 1030 trains the restoration model 1021a to output the restored image in response to the input of the captured image, the restored image as the captured image in which the stained areas are reduced in different degrees in accordance with the positions in the captured image by the machine learning method based on the restored image outputted by the restoration processing unit 1020, the ideal image serving as the captured image in which the stained areas are removed, and the importance map 1031 indicating the correspondence between any positions in the captured image and the restoration degree indicating the degree to reduce the stained areas.

According to the restoration model generation device 1000, the restoration model 322a may be appropriately generated, the restoration model 322a which may reduce the stained areas in different degrees in accordance with the positions thereof in the captured image to establish the image restoration device 100 that may reduce the stained areas more efficiently by the appropriate training of the restoration model 1020a by the machine learning method.

According to the disclosure, the importance map 1031 is a predetermined map. The learning processing unit 1030 corrects the difference between the restored image and the ideal image by each of the positions, and trains the restoration model 1020a by the machine learning method to decrease the difference after the correction.

Thus, the restoration model 1021a may be easily trained by using the predetermined importance map 1031.

In this case, the restoration degree of the importance map 1031 is specified or set to correct the difference between the restored image and the ideal image more largely at the predetermined positions where the necessity of visual confirmation by the passenger is high in the captured image.

According to the configuration, the restoration model 1021a may be easily trained to obtain the restoration model 322a which may more efficiently and specifically reduce the stained areas.

The restoration degree of the importance map 1031 is set or specified to correct the difference between the restored image and the ideal image more largely at the predetermined areas where the necessity of visual confirmation by the passenger of the vehicle 1 is high in the captured image.

According to the configuration, the restoration model 1021a may be easily trained to obtain the restoration model 322a which may more efficiently and easily reduce the stained areas.

According to the disclosure, the learning processing unit 1030 classifies the restored images into the plural areas in accordance with the subjects captured in the restored image by the predetermined classifier, and generate the importance map 1031 by specifying or setting the different restoration degrees by each of the plural areas.

According to the configuration, the restoration model 1021a may be easily trained to obtain the restoration model 322a which may more efficiently and flexibly reduce the stained areas.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. An image restoration device, comprising:
an acquisition processing unit configured to acquire a captured image obtained by an imaging unit capturing surroundings of a vehicle; and
a restoration processing unit, wherein
in a case where the captured image includes a stained area caused by a stain of an optical system of the imaging unit, the restoration processing unit is configured to output a restored image corresponding to the captured image acquired by the acquisition processing unit based on a restoration model pre-trained by a machine learning method to output the restored image serving as the captured image in response to an input of the captured image, the restored image in which the stained area is reduced in a different degree in accordance with a position of the stained area in the captured image.

2. The image restoration device according to claim 1, wherein the restoration model is configured to output the restored image in which the stained area included at a predetermined position where a necessity of visual confirmation by a passenger of the vehicle is high in the captured image is reduced in a larger degree than the stained area included in the other position.

3. The image restoration device according to claim 1, wherein the restoration model is configured to output the restored image in which the stained area included in a predetermined area where a necessity of visual confirmation by a passenger of the vehicle is high in the captured image is reduced in a larger degree than the stained area included in the other area.

4. The image restoration device according to claim 1, wherein the restoration model is configured to output the restored image in which the stained area is reduced in a different degree by each of plural areas corresponding to a result in which a predetermined classifier classifies the captured image in accordance with a subject captured in the captured image.

5. A restoration model generation device comprising:
an acquisition processing unit configured to acquire a captured image obtained by an imaging unit capturing surroundings of a vehicle, the captured image including a stained area caused by a stain of an optical system of the imaging unit;
a restoration processing unit configured to output the restored image corresponding to the captured image acquired by the acquisition processing unit based on a restoration model outputting the restored image serving as the captured image in response to an input of the captured image, the restored image in which the stained area is reduced; and
a learning processing unit configured to train the restoration model to output the restored image in response to the input of the captured image, the restored image serving as the captured image in which the stained area is reduced in a different degree in accordance with a position of the stained area in the captured image by a machine learning method based on the restored image, an ideal image, and a map, the restored image outputted by the restoration processing unit, the ideal image serving as the captured image in which the stained area is removed, and the map indicating correspondence between any position in the captured image and a restoration degree indicating a degree to reduce the stained area.

6. The restoration model generation device according to claim 5, wherein
the map is predetermined; and
the learning processing unit is configured to train the restoration model by the machine learning method to correct a difference between the restored image and the ideal image at each of the positions thereof in accordance with the restoration degree, the machine learning method to decrease the difference after the correction.

7. The restoration model generation device according to claim 6, wherein the restoration degree of the map is specified to correct the difference between the restored image and the ideal image larger at a predetermined position where a necessity of visual confirmation by a passenger of the vehicle is high in the captured image than the other position.

8. The restoration model generation device according to claim 6, wherein the restoration degree of the map is specified to correct the difference between the restored image and the ideal image larger at a predetermined area where a necessity of visual confirmation by a passenger of the vehicle is high in the captured image than the other area.

9. The restoration model generation device according to claim 5, wherein
a predetermined classifier classifies the restored image into plural areas in accordance with a subject captured in the captured image in response to that the restoration processing unit outputs the restored image; and
the learning processing unit is configured to generate the map by specifying the restoration degrees which are different from one another by each of the plural areas.
